(19) United States
(12) Patent Application Publication
(10) Pub. No.: US 2026/0232141 A1
(43) Pub. Date: Aug. 13, 2026

(54) FOOD PROCESSOR AND METHOD FOR PREPARING FOOD

(71) Applicant: Vorwerk & Co. Interholding GmbH, Wuppertal (DE)

(72) Inventors: Tobias Kuhlen, Wuppertal (DE); Sven Hügging, Dortmund (DE); Jana Demtröder, Dortmund (DE); Sabrina Grüber, Bochum (DE)

(21) Appl. No.: 19/540,309

(22) Filed: Feb. 13, 2026

(30) Foreign Application Priority Data
Feb. 13, 2025 (EP) 25157592.4

(51) Int. Cl. A47J 43/07

(52) U.S. Cl. CPC A47J 43/0716

(57) ABSTRACT

The present disclosure relates to a food processor and a method for preparing a food using a food processor. A food processor (1) comprises a base part (3), the base part (3) having an interface (9) for mechanical and/or electrical coupling with an attachment (5). The food processor (1) is configured to recognize a type of attachment (5) and to influence a function of the interface (9) depending on the recognized type of attachment (5) in order to operate the attachment (5) for food preparation. In this way, the interface can be used flexibly.

### PRIORITY CLAIM

This application claims priority to European Patent Application No. 25157592.4, filed February 13, 2025, which is hereby incorporated in its entirety herein.

### FIELD OF THE DISCLOSURE

The present disclosure relates to a food processor and a method for preparing food using a food processor.

### BACKGROUND

The food processors known from the prior art comprise a base part and a food preparation vessel that can be mechanically and electrically coupled to the base part. Publication EP 2 698 088 B1 discloses an electrically operated food processor in which a lid of a cooking vessel is locked from above by means of two rollers which, in a closed position, block the lid from being removed upwards in a form-fitting manner.

The task of the present disclosure is to provide a further developed food processor and an associated method for food preparation.

### SUMMARY

A food processor comprising a base part is disclosed. The base part preferably comprises an interface for mechanical and/or electrical coupling with an attachment. In particular, the food processor, e.g., the base part, is configured to recognize (detect/identify) a type of the attachment. In particular, the food processor, e.g., the base part, is configured to influence a function of the interface depending on a recognized type of attachment. This serves in particular to operate an attachment for food preparation.

The designs according to the present disclosure allows the interface of the base part to be used flexibly and its use to depend on the attachment recognized. Depending on the attachment recognized, the behavior of the interface can be automatically adjusted to prepare food. Each attachment can be operated automatically with the respectively required functions. Incorrect operation is ruled out. In addition, an additional attachment that requires other functions of the interface can be retrofitted and used with minimal effort. This makes it easy to expand the range of functions.

A food processor may comprise a base part and an attachment that can be connected to it. Typically, the base part holds and/or carries the attachment and/or serves for control. The base part is typically suitable for being placed on a surface. In particular, the base part has an output device and/or an input device. The base part typically comprises a motor for driving a rotatable tool or for driving a tool holder for a tool in the attachment. When connected, the base part can supply electrical energy to the attachment, rotate a tool of the attachment, and/or transfer data to and/or from the attachment. The base part can preferably supply electrical energy for functional components of the attachment.

An attachment may be, for example, a food preparation vessel, e.g., a pot, a pan, a steamer, a pressure cooker (steam cooker), a chopping device, a popcorn machine, a deep fryer, or a mixing bowl. An attachment may be a food preparation vessel that combines several of the functions mentioned. A food preparation vessel is a vessel into which food or an ingredient for food can be placed for the purpose of performing a preparation step. Food within the meaning of the present disclosure also comprises individual ingredients. A preparation step may comprise, for example, heating, stirring, chopping, and/or resting. A food preparation vessel may be one-piece or multi-piece. A variety of attachments may be present which may differ, for example, in height, diameter, type, supported functions, and number of functional components.

An attachment may have one or more functional components, for example, a tool for food preparation which is in particular rotatable, such as a stirring tool, a kneading tool, a mixing knife, or a cutting and/or grating disc. The tool may be used for stirring and/or chopping food. The drive of the tool is discussed in detail below. In one embodiment, the tool can be mounted on a tool holder that is connected to the attachment.

Alternatively or additionally, an attachment may comprise a heating device as a functional component in order to heat the attachment and/or food located therein. There may be one, two, or more heating devices, which can be controlled together and/or individually. For example, there may be a thick-film heater, a tubular heater, and/or a flat heater. An attachment may also comprise one or more sensors, for example a temperature sensor, a pressure sensor, and/or a sensor for recognizing the type of a function module. An attachment may also have a wired or wireless interface for transmitting and/or receiving data.

Any attachments with any combinations of functional components are possible. An attachment may be a food preparation vessel having only one or more temperature sensors. Multiple temperature sensors allow the temperature to be determined more accurately and/or with higher spatial resolution. The food preparation vessel then has no heating device and no rotating tool. Such a food preparation vessel can be used, for example, for rising dough. Another attachment can be a pan that has a heating device but no rotating tool. A further attachment can be a stirring vessel that is designed only for low speeds.

The interface serves to mechanically and/or electrically couple the attachment to the base part. In particular, mechanical coupling refers to a direct mechanical coupling in which the attachment and the base part are in contact. For mechanical coupling, the interface is in particular a physical interface. In this way, the attachment can be supported or held by the base part. Coupling preferably means positioning the attachment in or on the interface in such a way that the attachment can be operated with the base part for food preparation. Typically, at least a large part of the attachment is then located above at least a large part of the base part. The attachment is therefore placed on (top of) the base part. The attachment may have a corresponding interface that can be coupled with the interface of the base part.

The interface can basically be of any shape, for example as a flat surface. The interface may advantageously comprise a receptacle for inserting the attachment. The attachment can be inserted into the receptacle in order to be operated there. The receptacle can be designed as a recess or have one or more recesses into which the attachment or individual components of the attachment can be inserted. In this case, at least one section of the attachment is moved under at least one section of the base part during placement. Preferably, the interface is configured such that at least lateral movement of the attachment relative to the base part is blocked, in particular by a positive connection. This prevents the attachment from slipping. Removal of the attachment from the base part with an upward movement of the attachment is typically possible, provided that the attachment is not locked to the base part. Typically, the interface is configured to couple different attachments to the base part.

The interface can also be used to control the attachment and/or functional components of the attachment for food preparation. The interface can have different functions that can control different areas of an attachment and, if necessary, a function module.

The food processor is configured to recognize the type of attachment. A control device of the food processor can be configured to receive information regarding the type of attachment.

Recognizing a type or kind of the attachment may comprise classifying it into a product class. For example, it may be recognized that it is a pot, a pan, or a mixing bowl. It may also be recognized whether it is a pot with a small or large volume. In particular, recognizing the type comprises identifying a predefined product model. This can enable knowledge of certain properties of the product, such as functional components available with the pot, food preparation processes that can be performed with the pot, and/or properties of the pot, such as a maximum temperature to which the pot may be heated, the maximum speed of the attached tool, or a maximum pressure inside the pot. In one configuration, each individual attachment can be recognized by means of a unique identification.

The food processor influences the function of the interface in order to operate the attachment for food preparation. For example, the food processor, in particular a control device, causes an operating part or a shaft to rotate or one or more electrical contacts to be activated in order to transmit data and/or energy. In this way, functional components of the attachment can be operated for food preparation.

The food processor can automatically adjust the function of the interface in response to the recognized type of attachment. In particular, the user does not need to take any action. For example, the food processor can recognize that a container with a knife-shaped tool is coupled to the base part, on which a lid is placed and locked. In this case, the food processor can enable the shaft to rotate at high speed, for example to chop a solid food. If, on the other hand, it is recognized that a pan without a rotating tool is coupled to the base part, the motor for rotating the shaft is switched off.

In particular, the food processor is configured to check for the presence of an attachment and, if necessary, to influence a function of the interface depending on the result of the check. The food processor can be configured such that the check is performed during a start or every start of the food processor. For example, rotation of the shaft can be deactivated as long as no attachment or no attachment with a rotating tool is coupled. Typically, the system first checks whether an attachment is present and, if so, then recognizes the type of attachment.

In one configuration, the interface further comprises a rotatable shaft for driving a rotatable tool of the attachment. In particular, the base part comprises a motor for rotating the shaft. The shaft typically has a non-circular contour, in particular on the upper side, which can be connected in a rotationally fixed manner to a corresponding contour on the attachment. The attachment may have a connecting shaft to transmit the rotation of the shaft of the base part to the tool. The connecting shaft may have a non-circular contour, in particular on the underside of the attachment, which can be connected in a rotationally fixed manner to the corresponding contour of the shaft on the base part.

The shaft can be a function of the interface, which can be influenced depending on the type of attachment recognized. For example, a pot can be recognized that has no lid and/or is only designed for low rotational speeds. In this case, the food processor can control the interface so that the rotatable shaft is not rotated faster than a predefined maximum rotational speed.

In one embodiment, the interface comprises a rotatable operating part for performing a function, in particular on the attachment. A function may consist of performing, operating, controlling, or triggering a function, for example, a functional component of an attachment or a function module connected thereto. A possible function of the attachment may be, for example, the locking of the attachment with the base part, in particular in a form-fitting manner. The attachment cannot be removed from the base part when locked. Furthermore, a function of the attachment can be triggered, such as opening or closing a valve on the attachment. Another possible function may consist of moving a movable part of the attachment, such as a transmission device. The transmission device may in turn perform a function, for example, locking a function module on the attachment or controlling a function of the function module, such as opening or closing a valve on the function module or operating a switch or button. A function may also consist of moving a locking element to enable or disable the movement of another part. In principle, the rotary movement of the operating part can be used directly to perform the function and/or a single or multiple conversion into another movement can be performed for this purpose, which may be linear, for example, or a rotary movement about another axis of rotation.

In principle, a function can also consist of rotating an accessory part, such as a rotatable tool, in the attachment, for example, setting it in oscillating motion or setting it in stepwise rotation in one direction of rotation by means of oscillating movements. This can be done independently of a driven shaft of the base part for driving a rotatable tool.

In one embodiment, the base part comprises an actuator for driving the operating part. The actuator is in particular electrically operated and can be designed as an electric motor, e.g., as a servomotor. The actuator is in particular arranged below the receptacle and/or the attachment. The actuator serves to rotate the operating part and thus perform the described function or functions in an automated manner.

In particular, the food processor is configured to control the actuator depending on the recognized type of attachment in order to influence a position or movement of the operating part. In other words, the actuator and/or the drive of the operating part is a function of the interface that can be influenced or controlled. This allows the position of the operating part to be adjusted depending on the type of attachment. For example, it can be recognized that the attachment is a food preparation vessel that can be locked to the base part and that a rotation from an initial position by a certain angle in a certain direction locks the food preparation vessel to the base part. The actuator can be controlled so that the operating part performs the described rotation when locking is desired or required.

In one configuration, the food processor comprises a control device that is configured to control the actuator. The control device can control a position and/or movement of the operating part depending on the type of attachment. In particular, the control device is configured to move the operating part to specific rotational positions.

In one embodiment, the operating part has at least one contact element. The contact element can be used to positively lock the attachment to the base part. In particular, the contact element contacts a corresponding element of the attachment. In particular, this prevents the attachment from being lifted in the axial and/or vertical direction in a form-fitting manner when locked. In a supplementary or alternative configuration, the contact element serves to transmit the rotational movement and/or force of the operating part to a component of the attachment. In particular, the attachment has a corresponding element which contacts the contact element of the operating part, is moved by it and/or is subjected to force by it.

In particular, the contact element protrudes in the radial direction from the adjacent structure of the operating part, for example outwards. In particular, there are several, for example three, contact elements which can be distributed around the circumference.

The operating part is rotatable (can rotate) around a rotational axis. In one configuration, the operating part can rotate around an at least substantially vertical axis and/or around a rotational axis that is aligned parallel to a rotational axis of a shaft for driving the food preparation tool. This allows, in a particularly advantageous manner, parallel alignment of the rotational axes. For example, this allows the attachment to be locked from below. It is particularly preferred that the operating part and the shaft have the same axis of rotation. In one configuration, the operating part is ring-shaped, for example circular, typically in relation to the axis of rotation. In other words, a space is free in the radial interior of the operating part. This makes it possible to accommodate one or more other components of the base part or the food processor there, for example, a shaft for driving a tool for food preparation.

In one embodiment, the interface comprises several electrical contacts for transmitting data and/or electrical energy between the base part and the attachment. In particular, the electrical contacts serve to provide an electrically conductive connection to the attachment. In particular, the attachment comprises at least one, typically several corresponding electrical contacts. One function of the interface that can be influenced depending on the recognized type of attachment is the electrical contacts.

Electrical energy comprises electrical voltage and electrical current. The transmission can serve to transmit data and/or electrical current from the base part to the attachment. The transmission can serve to receive data and/or electrical current from the attachment by the base part. For example, current can be provided to operate a heating device or a sensor in the attachment or in a function module. For example, data from a sensor and/or data from a function module forwarded by the attachment can be forwarded.

If both electrical power and data are to be transmitted, an electrical contact can in principle be used for both functions, possibly even simultaneously. However, different electrical contacts may also be provided for power and data. On the one hand, one or more power contacts may be provided for the electrical supply of functional components such as a heater, and on the other hand, one or more data contacts may be provided for the transmission of data. However, data contacts may also be configured to supply electronic components such as microelectronics or a sensor with electrical energy.

In one embodiment, the food processor is configured to control the use of at least one electrical contact depending on the type of attachment recognized. The use of an electrical contact may comprise whether a specific contact is activated (used). For example, a first type of attachment may use all electrical contacts, while a second type of attachment may not use at least one electrical contact. The food processor then influences the interface in such a way that no electrical energy and no data are to be transmitted to the unused contact and no electrical energy and no data are received from the unused contact.

For example, a first food preparation vessel may have two independent heating devices that are supplied with power via three electrical contacts. A second food preparation vessel may have only one heating device, which is supplied with power via two electrical contacts. If the food processor detects that a second food preparation vessel is present, a specific electrical contact is not used. Preferably, the food processor has access to information about which contacts are used and/or not used.

The use of an electrical contact may comprise how a specific contact is controlled. For example, a third food preparation vessel may have a heating device that only allows food in the food preparation vessel to be heated to 40°C. In this case, the same contacts are required for the same purpose, namely to apply an electric current, as in the second food preparation vessel, but the electric current is limited to a low amperage. The food processor then limits the current to be applied to a preset value corresponding to the permitted heating.

In one embodiment, the food processor comprises a position sensor for detecting a rotational position of the operating part. The position sensor is arranged in particular on the base part. In particular, the position sensor is configured to determine at least the current rotational position. Preferably, the position sensor is configured to determine any rotational position of the operating part. This means that not only specific positions can be determined, as is the case with end stops, for example. In particular, any rotational position can be determined within the angular range in which the operating part can rotate. The rotational position of the operating part allows a very precise statement to be made about the function to be performed. For example, an active position is provided in a specific attachment or function module in a specific angular range, in which a specific function is active, and a passive position in another angular range, in which a specific function is not active. The determined rotational position thus makes it immediately apparent whether a specific function is active. The food processor can be configured such that a desired function, such as chopping food with a chopping tool, only takes place after a specific position has been detected, which indicates, for example, that the attachment is locked to the base part. In particular, the base part is configured such that the position sensor or a control device connected to the position sensor outputs a signal when the position sensor detects that a predefined rotational position has been reached.

This allows the reaching of a desired rotational position to be monitored and food preparation to be carried out particularly quickly and safely.

In one embodiment, the position sensor is configured to detect an absolute rotational position of the operating part. The position sensor thus provides an actual physical rotational position of the operating part within the possible angular range.

In one configuration, the position sensor has a signal element connected to the operating part, and a detection device arranged on the base part. The detection device can detect the position of the signal element. The signal element is, for example, a metallic element.

The signal element can rotate with the operating part. In particular, there is no relative rotation between the signal element and the operating part. The rotational position of the signal element thus allows a precise and unambiguous conclusion to be drawn about the rotational position of the operating part without tolerances, such as those found in connected parts of a gearbox, affecting the accuracy. In particular, the detection device is arranged on a non-rotating part of the base part so that the signal element rotates relative to the detection device. There is no relative rotation between the detection device and a housing of the base part. In one configuration, the detection device has a shape curved around the axis of rotation of the operating part. In particular, the detection device has the shape of a circular arc. This allows for the most uniform possible distance between the signal element and the detection device, regardless of the rotational position. In particular, the detection device extends over the entire angular range through which the operating part can be rotated. In particular, the detection device is an inductive detection device.

In particular, the food processor is configured to check whether the operating part is in an initial position and/or in which rotational position the operating part is. The initial position of the operating part may be necessary in order to couple an attachment to the base part. The food processor may be configured such that the check is performed during a start or each start of the food processor. If the operating part is in a different rotational position, the operating part can be rotated to the initial position. The check can also be performed when the food processor recognizes that a certain type of attachment is present. A certain rotational position of the operating part may be required for a certain operation of a functional component, for example the initial position or a certain position, for example, a position known to the food processor depending on the type of attachment, which indicates a certain state, such as a locked state.

In one embodiment, the interface has a receiving unit for receiving information for the purpose of recognizing the type of attachment. In particular, the receiving unit comprises at least one electrical contact of an interface, in particular a data interface. In this case, the information is received via an electrical contact that is configured solely for receiving and, if necessary, also for transmitting data.

In particular, the attachment comprises an identification. For example, an electrically or electronically stored and/or digital identification may be present, for example in the form of a unique number. The attachment may have a data memory and/or a control unit. In particular, the attachment comprises a corresponding unit that can be coupled to the receiving unit of the interface for data purposes. The receiving unit can then receive data, preferably on the type and, if applicable, the identity of the attachment. The transmission can be analog or digital, for example.

The receiving unit may have a data interface which is in particular digital. The data interface is specifically provided for transmitting data. A power contact, for example to provide power for operating a function module, is not a contact of a data interface. Preferably, a control device can receive the sensor data and influence the function of the interface on this basis. The receiving unit and, accordingly, the unit on the attachment can be designed as radio units. In particular, the receiving unit comprises at least one electrical contact. In this way, data can be transmitted easily and without errors.

In one embodiment, the base part has access to properties of the recognized type of attachment. In particular, the base part is configured to control the function of the interface depending on the properties of the attachment. The food processor may have a control device that has access to the properties. The properties may be properties of the recognized type of attachment. The properties may be properties of a specific recognized attachment. The properties may be used as a basis for controlling the interface.

For example, the food processor has access to information specifying which function or functions of the interface are used and, in particular, how these function or functions are used. For example, a data record, such as a table, may be available which stores, for each type of attachment, whether and/or how one or more of the electrical contacts, the operating part, and the shaft are used. The information, e.g., the data record, may be stored in the food processor and/or in the base part, for example in firmware, entered into the base part or received from a mobile device, downloaded or available via a network, stored in the attachment itself and transferred from there to the base part if necessary.

The properties of an attachment may comprise, for example, one, several, or all of the following: possible types of food preparation; can be locked; how it can be locked (e.g., direction of rotation and/or angle of rotation of the operating part); volume, area, presence, number, and type of heating devices; presence, number, and type of sensors; presence of a rotatable tool; functions of the tool, for example depending on the direction and/or speed of rotation; possibility of coupling with function modules; which function modules can be coupled; can a function module be locked; which functions of a function module can be controlled; how can the functions of the function module be controlled (e.g., direction of rotation and/or angle of rotation of the operating part); etc.

For example, the control device can then only control the electrical contacts of the interface that are relevant to the recognized attachment, only perform the provided rotation of the operating part or the shaft, etc. All electrical contacts of the interface that are not present or not used are then not controlled. Unintended directions of rotation or rotational speeds of the operating part are not executed.

In one configuration, the food processor comprises the attachment. In one embodiment, the attachment is a food preparation vessel. In one embodiment, the attachment has an interface for mechanical coupling with a function module. The interface is located in particular on the upper side of the attachment. The function module is configured in particular to be placed on or into the attachment from above. The food processor may comprise the function module.

A function module is a part that is used together with the attachment and performs a specific function. A function module can be a cover part that at least partially covers the attachment. A function module can, for example, be a lid that protects against reaching in and/or splashing. A function module can be configured to perform one or more specific food preparation processes. A function module can be a chopping part for chopping food. A function module can, for example, be a cutting unit, such as a cutting disc, a grating disc, or a juicer and/or juicer attachment. The function module may be one-piece or multi-piece. A chopping attachment may, for example, comprise a collection basket, a chopping tool, a connecting shaft, and a lid. The attachment alone or together with the function module may form a popcorn machine.

In particular, different function modules are available, each of which can be combined with one or more different attachments. In particular, the interfaces of the different attachments are shaped to correspond to each other. In particular, each function module has a corresponding interface for coupling with the interface of the respective attachment. The mechanical coupling can be a force-fit and/or form-fit coupling. At least transversely to the axial direction, a form-fit coupling typically takes place. The function module can then still be removed upwards, but cannot slip sideways. It may be possible to lock the function module to the attachment, e.g., using the transmission device of the attachment. In a locking position, a lock can then be produced which is in particular form-fitting so that the function module can no longer be removed from the attachment.

In one embodiment, the food processor is configured to recognize a presence and/or type of the function module. In particular, the food processor is configured to influence a function of the interface depending on the recognized presence and/or type. Analogous to the type of attachment, the type of function module can also be used to influence the function of the interface. The above statements regarding influencing the interface apply here analogously. In addition, the information that no function module is present can also influence the function of the interface. For example, if the absence of a lid on a food preparation vessel is detected, the rotation of a rotatable tool can be limited to a low speed or even prevented.

The food processor can use the available information to enable, disable, or enable with at least one modified parameter a specific operation of a specific functional component. For example, a modified speed, direction of rotation, or temperature of a heating device can be used as a parameter.

In particular, the food processor, preferably the attachment, comprises at least one receiving unit for receiving information for the purpose of recognizing the type of function module. In one configuration, the receiving unit comprises at least one sensor for recognizing the type of function module. The sensor can be configured to detect a magnetic field. For example, at least one Hall sensor can be used, in particular a 3D Hall sensor. In this way, the three-dimensional vector of the magnetic flux density can be measured. One or more magnets can be arranged on the function module, with which the type of function module can be coded. In particular, two or more magnets are used. In particular, two or more Hall sensors are used. For some applications, a single Hall sensor may be sufficient.

Alternatively, any other suitable sensor may be used. For example, an electrical resistor may be arranged in each function module, which can be read out via electrical contacts on the function module. Each type of function module has a characteristic resistance, which the food processor can use to identify the type. Typically, the attachment then comprises suitable electrical contacts to produce an electrical connection from the function module to the base part when the function module is coupled and/or to query the resistance.

It is also possible to receive data about the type of function module. For example, a near-field communication or Bluetooth transmitter can be located in the function module and a corresponding receiver in the food processor. An identification stored in the function module can also be read out by the attachment or the base part, analogous to the identification of the attachment described above, which applies here accordingly.

The receiving unit serves to recognize the type of function module. The receiving unit may be configured to output an electrical signal that encodes the type of function module. The receiving unit is preferably located on the attachment. In particular, a data connection can be established or is present between the attachment and the base part, via which the electrical signal can be transmitted to a control device in the base part. The data connection can be wired or wireless. A section of the data connection may be formed by one or more electrical contacts that are part of the interface. A receiving unit can also be located on the base part. For example, corresponding signals can be transmitted from the attachment to the base part.

In one configuration, the food processor is configured such that a function of the interface performs an action on the function module. In one embodiment, the attachment has a transmission device, in particular a mechanical transmission device, for transmitting a force and/or movement of the operating part, in particular for the purpose of performing a function on the function module. The transmission device can then have an element that interacts with the contact element of the operating part. The transmission device can be configured to transmit the movement to the function module. For this purpose, the transmission device and the function module can also have corresponding contact elements. The function in the function module comprises, for example, a movement of a component of the function module. The movement of the component can have different consequences, for example, opening or closing an opening or a valve, indicating a status, etc. The transmission device can, for example, be rotatable, in particular about the same axis of rotation as the operating part.

Alternatively or additionally, the transmission device itself can perform a function. The transmission device can have a locking element on the upper side with which the function module can be locked to the attachment. For example, the transmission device and/or the function module has one or more form-fit elements. The respective other part is shaped such that, in a suitable relative rotational position between the transmission device and the function module, referred to as the locking position, it engages with the form-fit elements and produces a positive lock. This prevents the function module from being removed from the attachment. In another rotational position, the release position, the locking is released and the function module can be removed, in particular manually. One or more form-fit elements may also be arranged on the function module. In principle, a force-fit locking can also be provided, for example by exerting force on a rubber or spring element.

The transmission device may be arranged between an inner wall of the attachment and an outer wall of the attachment. There may also be thermal insulation between the inner wall and the outer wall, or the outer wall can be designed as thermal insulation. It may be provided that the attachment can only be coupled to the base part when the transmission device is in the initial position. A bias element, for example comprising one or more springs, may be provided to bias the transmission device into an initial position. This ensures that the attachment can always be easily coupled to the base part.

In one embodiment, the base part and the attachment are configured such that the attachment can be mechanically coupled to the base part in an initial position of the operating part. The attachment can then be placed on the base part, for example, and, in particular, removed manually. In one embodiment, the base part and the attachment are configured such that the attachment is locked to the base part in a second rotational position of the operating part that differs from the initial position. In particular, the locking takes place as described via the contact element of the operating part. In this position, the attachment typically cannot be placed on the base part or removed from it.

In particular, the base part and the attachment are configured such that, in a third rotational position of the operating part that differs from the initial position and the second rotational position, at least one locking element of the attachment that is operatively connected to the transmission device is in a locking position in order to lock a function module. Alternatively, another action can be performed on the function module in the third rotary position. In particular, the initial position, the first rotary position, and the second rotary position are passed through in this order one after the other. If the operating part is rotated from the initial position in one direction of rotation, the attachment is locked. If rotation is continued in the direction of rotation, the function module is locked or the other action is performed. One or more additional actions may be performed before and/or in between.

In one embodiment, the food processor is configured such that it performs a predetermined action in the event of a failed attempt to rotate the operating part into a desired position. The predetermined action depends in particular on the recognized type of attachment and/or function module. For example, it may not be possible to turn the operating part into a locking position, e.g., due to an incorrectly attached attachment or function module, due to contamination, or due to damage. The food processor then performs a predetermined action. For example, a desired operation can be blocked, an operation with at least one changed parameter can be permitted or performed, and/or information can be output to a user. The action may also depend on the recognized position and/or the current operation of the food processor. If a lid is recognized on a food preparation vessel and the malfunction occurs during locking, the operation of a cutting tool may be blocked or restricted. If, on the other hand, the malfunction occurs during unlocking, only information may be output to the user.

In one embodiment, the food processor is configured to adapt the function of the interface depending on the current operating status of the food processor. In particular, a control device has information about the current operation. The current operation may comprise, for example, the temperature, speed, direction of rotation, status of an attachment, status of a function module, locking status of an attachment, locking status of a function module, and/or operating parameters set and/or specified by the user or by the recipe. The current operation may provide information about the current state of the attachment or a food item in the attachment. If, for example, high temperatures, e.g., 95 °C, are reached when potatoes are being cooked, locking may be necessary, thereby preventing the lid from being removed directly.

In one embodiment, the function module is a lid for covering the attachment. In one embodiment, the function module assumes a raised position in the event of a force acting on the function module from below or from within. In particular, it is not possible to unlock the function module in the raised position. In particular, the food processor is configured to recognize whether the type of attachment and function module allow the raised position of the function module. In particular, if this is the case, the food processor can be configured to insert a waiting time after a failed attempt to unlock the function module and then make another attempt to unlock the function module. In particular, the food processor has information about which movement is necessary to unlock the function module.

The function module can be pushed upwards by the force acting on the function module from below. The force can be generated, for example, by overpressure in the attachment, a vortex in the attachment, i.e., a funnel-shaped liquid surface caused by rotation, or overfilling of the attachment. The force arises in particular inside the attachment and acts on the underside of the function module. The attachment and/or the function module can be designed in such a way that, when such a force is present, unlocking is mechanically impossible. For example, a locking element can interact with a guide in such a way that the locking element moves against a stop, which prevents unlocking, due to the changed position of the function module. When the force is removed or falls below a threshold value, the function module lowers again, the locking element moves past the stop, and unlocking can take place. Such a mechanism can be referred to as a pressure pocket.

The food processor can detect the failed attempt, for example, by an increased motor current in a certain range of the rotational position of the operating part when the operating part is rotated to an unlocking position. The food processor can then rotate the operating part back to the locked position. When another attempt is made, the actuating part is rotated again toward the unlocking position. This may result in unlocking, or another failed attempt may occur. If necessary, this can be repeated several times until unlocking occurs. A waiting time of, for example, a few seconds, in particular at least 1 s and/or at most 10 s, can be provided. In this example, the attachment is in particular not a pressure cooker. A pressure cooker typically has a valve for pressure relief.

In one configuration, the food processor comprises a control device. The control device may be configured to control a food preparation process using the attachment. The control can be carried out depending on the recognized type of attachment. The control device may be configured to control one or more electrical contacts of the interface, the operating part, and/or the shaft. Control may be based, for example, on an electronically stored recipe, an operating mode selected by the user, or an instruction entered by a user. Control may comprise whether and/or how a function is activated. The control device is located in particular in the base part. Preferably, the control device comprises a processor and a memory with a computer program code, i.e., commands that can be stored on the memory. The processor, the memory, and the computer program code are configured so that a method with several process steps can be performed.

In one embodiment, the food processor is configured to execute a function of the interface based on a user input or an electronically stored recipe. In particular, the food processor is configured such that, in response to an instruction from the user or the recipe, the function of the interface is executed depending on the recognized type of attachment and/or function module. In this embodiment, a specific instruction may be executed differently or variably depending on the attachment and/or function module used.

If, for example, the recipe or the user specifies that a food is to be heated in a pot, the food processor recognizes the type of pot and has information about which heating devices are available for the pot and, in particular, how these are controlled. In this way, food preparation processes can be performed in a partially automated manner. The required electrical contacts are then supplied with the appropriate voltage and/or current and controlled in a suitable manner. In particular, the type and duration of the respective operation is specified by the recipe.

The function can be triggered in response to user input or to a recipe step to be processed. The function can be executed depending on user input or the recipe. For example, the user can set via a user interface or the recipe can specify via electronically stored data that a tool is to be rotated at a certain speed.

For example, the recipe may specify that the attachment and/or a lid on the attachment must be locked, for example if, according to the recipe, the volume or mass of food in the attachment exceeds a threshold value and/or if the temperature in the attachment or the rotational speed of a tool exceeds a predefined threshold value. The food processor has the information that the locking of the recognized attachment and/or lid must be performed by rotating the operating part from an initial position by a certain angle in a certain direction. The food processor influences the function depending on the type of attachment so that, in response to the recipe instruction, the operating part is rotated in the required manner to lock the attachment to the base part. If both the attachment and the lid are to be locked, the operating part is typically rotated by a larger angle. The function can also be adjusted during the processing of the recipe in order to respond to a reached operating state.

In another example, the user can set stirring at a specific speed. If the food processor recognizes that there is no lid on the attachment, it can limit the speed. If necessary, the speed is reduced in deviation from the user input in order to increase safety. The direction of rotation can also be influenced in this way. If a mixing knife is used, which stirs in a first direction of rotation and chops in the opposite, second direction of rotation, rotation can be limited to the first direction of rotation if there is no lid.

In one configuration, the food processor is configured to perform the preparation of food at least partially automatically on the basis of an electronically stored recipe. A control device of the food processor can access a recipe and be caused by a recipe step of the recipe to operate a functional component in a manner defined by the recipe step. The recipe can be configured such that at least one recipe step is selected depending on the recognized type of attachment. For example, it can be provided that frying onions is carried out in two passes with a small attachment, while one pass is sufficient with a large attachment. The food processor can then select the recipe step to be performed depending on the type of attachment. Alternatively, the food processor can modify a recipe step in order to execute a recipe that is valid for a first type of attachment, for example, with an attachment of a different second type.

In one embodiment, the food processor is configured to check, in particular before or during the operation of a functional component, according to an instruction from the user or the recipe, whether the operation is permissible according to the instruction from the user or the recipe for the type of attachment and/or function module. In one embodiment, the food processor is configured to refrain from operating the functional component according to the user's instructions or the recipe if operation according to the user's instructions or the recipe is not permitted.

If operation is not permitted, operation can be omitted entirely. For example, if there is no lid, no chopping of chocolate can be performed. Alternatively, in this case, operation can be carried out with at least one modified parameter. For example, if there is no lid, soup can be stirred at a reduced speed or kept warm at a reduced temperature. In this case, too, operation in accordance with the instructions is omitted, but a different operation takes place. This can increase safety.

For example, before each change of a parameter for operating a functional component, the food processor checks whether this parameter is permitted with the recognized attachment and/or function module. Such a check can also be carried out during the change of a parameter, for example at certain intervals. For example, when increasing the temperature, a lid may be required above a certain level to prevent boiling over. However, it may not be necessary to lock the lid. In order to take account of such continuous changes in the operating state or before startup, checks can be carried out at certain time intervals.

The food processor may be configured to provide information to the user. The cause of the non-compliance can be specified so that the user can remedy it, for example by putting on the lid. Once the cause has been remedied, it can be detected that the attachment and/or function module is present, and the desired operation can start.

A further aspect of the present disclosure is a method for preparing food using a food processor. The method comprises, in particular, recognizing, by the food processor, a type of attachment mechanically and/or electrically coupled to the base part. The method comprises, in particular, influencing, by the food processor, a function of the interface depending on the recognized type of attachment. The influencing may comprise: moving an operating part of the interface into a position predetermined by the type of attachment and/or an operating state of the food processor. Alternatively or additionally, the influencing may comprise: controlling or activating at least one electrical contact in a manner predetermined by the type of attachment and/or an operating state and/or rotating a shaft in a manner predetermined by the type of attachment and/or an operating state.

In one embodiment, the method comprises recognizing, by the food processor, a type of function module mechanically coupled to the attachment. In particular, the method comprises influencing, by the food processor, a function of the interface depending on the recognized type of function module. The influencing may comprise: moving an operating part of the interface into a position predetermined by the type of function module and/or an operating state of the food processor. Alternatively or additionally, the influencing may comprise: controlling or activating at least one electrical contact in a manner predetermined by the type of function module and/or an operating state and/or rotating a shaft in a manner predetermined by the type of function module and/or an operating state.

Exemplary embodiments of the present disclosure are explained in more detail below with reference to figures. Features of the exemplary embodiments may be combined individually or in plurality with the claimed subject matter, unless otherwise specified. The claimed scope of protection is not limited to the exemplary embodiments.

### BRIEF DESCRIPTIONS OF THE DRAWINGS

The figures show:

FIG. 1: a side view of a base part,

FIG. 2: a partially transparent enlarged detail of a base part,

FIG. 3: an interface of an attachment,

FIG. 4: a partially transparent side view of an attachment with a functional component attached,

FIGS. 5 and 6: diagrams showing the functions of an operating part, and

FIG. 7: a schematic drawing of a food processor.

### DETAILED DESCRIPTION

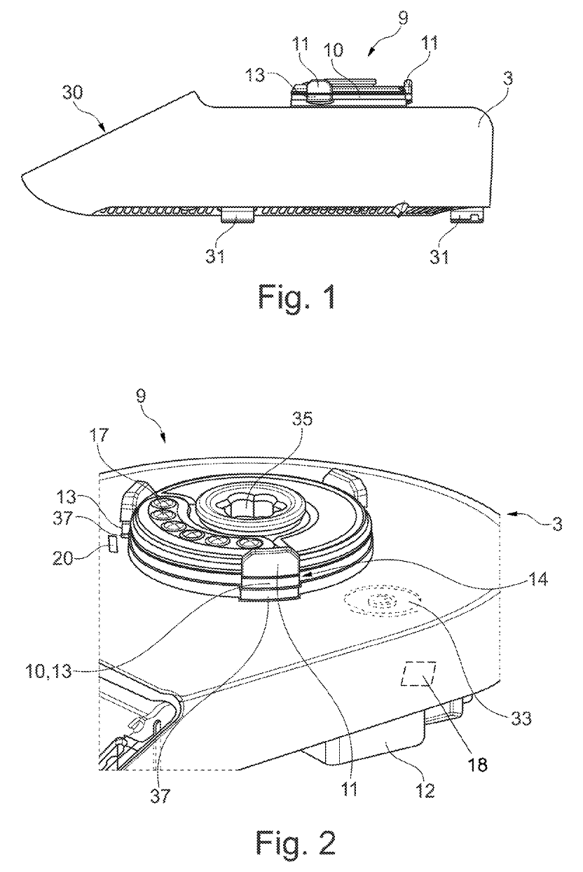

FIG. 1 shows a food processor comprising a base part 3. The base part 3 comprises feet 31 on its underside and is configured to be placed on a kitchen work surface. The base part 3 comprises a touch-sensitive display 30 on its upper side for input and output, as well as an interface 9 for the mechanical and electrical coupling of an attachment to the base part 3. The interface 9 comprises an operating part 10 with contact elements 13 and insertion elements 11, which are also visible in FIG. 2.

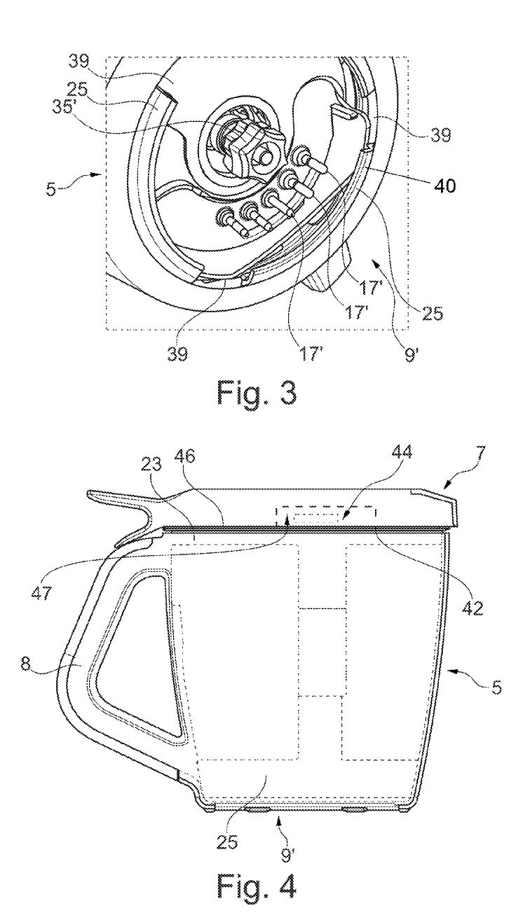

FIG. 2 shows the base part 3 with the interface 9 in enlarged form from an oblique top view. The base part 3 comprises a shaft driven by an electrical motor for driving a tool or a tool holder in an attachment. The shaft has a non-circular contour 35 on its upper side, which can be coupled in a rotationally fixed manner to a corresponding contour 35' of an attachment, as shown, for example, in FIG. 3. The contour 35 is typically located in the center of the interface 9. The interface 9 also comprises electrical contacts 17, which are located under a cover. The electrical contacts 17 serve to transmit electrical energy and/or information to and/or from the attachment. The interface 9 typically comprises a cover ring, which may comprise the cover and, distributed evenly around the circumference, three insertion elements 11, each of which has beveled edges and serves as an insertion aid when coupling the attachment.

The operating part 10 is ring-shaped and comprises three contact elements 13 distributed evenly around the circumference. Via an actuator 12 and, in particular, a gear, shown here as an example as a gear wheel 33, the operating part 10 can be rotated about its vertical axis, which preferably corresponds to the axis of the shaft. In the initial position of the operating part 10 shown, the contact elements 13 are aligned with the insertion elements 11 located above them and the locking hooks 37 located below them, as described below. The contact elements 13 have contact surfaces 14 and serve to perform various functions, in particular on the attachment. For example, the attachment can be locked to the base part 3, or a rotary movement or force can be transmitted to a transmission device of an attachment.

Below the operating part 10 there is a locking ring on which the outwardly protruding locking hooks 37 are arranged. Two locking hooks 37 are visible, while a third locking hook 37 is concealed. The attachment 5, which is shown in FIG. 3, comprises an interface 9' on its underside, with which it can be mechanically and electrically coupled to the interface 9 of the base part 3. When the attachment 5 is locked, the assembly consisting of insertion elements 11, contact elements 13, and locking hooks 37 (see FIG. 2) engages in the recesses 39 in the connecting ring 40. The connecting ring 40 is rotatably mounted in the attachment 5. When the operating part 10 is now rotated, the contact surfaces 14 of the operating part 10 contact the boundaries of the recesses 39 and the contact elements 13 rotate the connecting ring 40 with them. In doing so, the material of the connecting ring 40 adjacent to the recesses 39 is moved between the locking hooks 37 and the insertion elements 11. In this way, the attachment 5 is locked in a form-fitting manner with the base part, at least in the axial direction. In addition, this design allows the connecting ring 40 to be rotated further while the attachment 5 remains in the locked state. In particular, the attachment 5 and/or the interface 9 also comprise form-fit elements that prevent the attachment 5 from rotating in the interface 9.

When the attachment is placed on the interface 9, electrical contacts 17' of the attachment 5 are also connected to the electrical contacts 17 of the interface 9. The specific design of the respective contacts 17, 17' is irrelevant. In addition, the contour 35' of the attachment 5 is connected to the contour 35 of the interface 9 in a rotationally fixed manner.

FIG. 2 schematically shows that the base part 3 comprises a position sensor 20 with which a rotational position of the operating part 10 can be determined. In particular, a detection device of the position sensor 20 is connected directly or indirectly to a housing of the base part, while a signal element is connected in particular directly to the operating part 10. The detection device can thus determine the rotational position of the operating part 10 directly and very precisely. In addition, the food processor, in particular the base part 3, comprises a receiving unit 19 with which information about the type of attachment can be received. Preferably, the receiving unit 19 comprises at least one electrical contact 17, in particular of the interface 9, as shown. The attachment can then transmit electrical or electronic data identifying at least the type of attachment to the base part. Preferably, the food processor, in particular the base part 3, further comprises a control device 18.

In the configuration shown here, the connecting ring 40 (see FIG. 3) is part of a transmission device 25 (see FIG. 4) which extends in a wall of the attachment 5 or between an inner wall and an outer wall of the attachment 5 and is visible in FIG. 4. The transmission device 25 extends in particular from the interface 9' on the underside of the attachment 5 to a further interface 6 on the upper side of the attachment 5. The transmission device 25 is shown in dotted lines because it is located behind the outer wall of the attachment 5. A function module 7 can be mechanically and, if necessary, also electrically coupled to the interface 6 shown in FIG. 4. In FIG. 4, the attachment 5 is, for example, a food preparation vessel with a handle 8, and the function module 7 is a lid that can be locked onto the attachment 5. The transmission device 25 can be rotated by rotating the operating part 10 along the central, vertical axis of rotation of the operating part 10.

The transmission device 25 may have form elements in the area of its underside, for example for locking the attachment 5 to the base part 3. In the example described above in FIG. 3, these form elements are part of the connecting ring 40. In one example, the transmission device may comprise a bayonet geometry on the underside. It may be provided that the operating part 10 rotates the bayonet geometry and thus produces the locking. In a first rotary position of the transmission device 25, the function module 7 is thus locked on the attachment, and in a different, second rotary position, the function module 7 can be detached from the attachment 5.

The transmission device 25 may have form elements in the area of its upper side, which engage with corresponding elements of the function module 7, for example for locking a function module 7 to the attachment 5. A bayonet geometry 44 may be present on the upper side of the transmission device. In the exemplary embodiment shown here, the function module 7 comprises hooks 42 which engage with a ring 46 on the upper side of the attachment. As described above, pressure pockets 47 may be provided in which locking elements move against a stop, thereby preventing a raised cover from being unlocked.

Furthermore, the attachment 5 may comprise a receiving unit 23 for receiving information for recognizing the type of the coupled function module 7. The receiving unit 23 may send corresponding data to the base part by means of electrical contacts at the interface 9' of the attachment 5.

The food processor may be configured to execute one, several, or all of the following scenarios.

In scenario A), a pot is used as an attachment. There is no function module. The pot does not need to be locked to the base part. The operating part is not used. The food processor can recognize the type of attachment and, if applicable, the absence of the function module and/or check whether the desired operation is permissible with the available components and execute the operation accordingly, execute it in a modified form, or block it (not execute it). It can be recognized that the operating part is in the initial position. For example, a heating device of the pot can be operated by applying electrical current to one or two electrical contacts.

In scenario B), a pot is used as an attachment and a lid is used as a function module. After recognizing these components, the food processor can control the operating part such that the pot is locked to the base part and, in particular, such that the lid is locked to the pot. When heating with the lid locked, an unplanned force may be exerted on the lid inside the pot. The function module and the attachment can be designed in such a way that the function module is raised by the excess pressure, in which case the pot in particular remains tightly closed. When attempting to unlock the function module, it can be detected, for example by excessive current consumption of the actuator, that unlocking is not possible. This can be achieved, for example, by the pressure pockets described. After a waiting period, the food processor can make another attempt to unlock the function module.

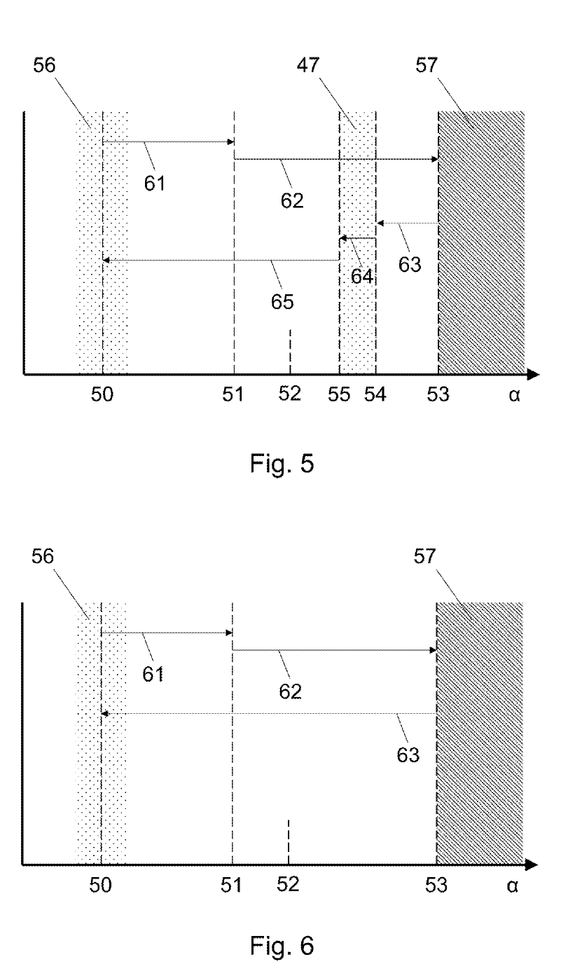

FIG. 5 shows a diagram of the functions of an embodiment of the food processor depending on the rotational position of the operating part, for example in scenario B). The food processor comprises an attachment mechanically coupled to the base part in the form of a pot and a functional module mechanically coupled to the pot in the form of a lid. The rotation angle α is plotted on the x-axis as a measure of the rotational position of the operating part. The initial position 50, which is defined as 0°, is an unlocked position in which the pot can be removed from or placed on the base part and in which the lid can be removed from or placed on the pot. The initial position 50 may correspond to the position shown in FIG. 2. There may be a confidence range 56 around the initial position 50, for example of ± 1°, to account for measurement inaccuracies.

When the operating part is rotated in a direction designated as the locking direction during a first rotation 61, it first reaches an intermediate position 51, which may be approximately 12°. In this position, the operating part has left the overlap with the locking hooks by about half. Up to this position, increased power consumption of the actuator can be tolerated in order to take into account any contamination that may occur over time, for example in the area of the locking hooks. This may prevent the locking from failing.

If the operating part is rotated further in the direction of rotation in a second rotation 62, it reaches the third rotational position 53, which corresponds to the locking position of the lid on the pot. It is irrelevant here whether the pot is locked to the base part or not. Further rotation in the direction of rotation is not provided for here as an example. The area to the right of the third rotational position 53 is too far 57 and is not reached in a non-defective system. This area could only be reached in the event of a fault.

If the operating part is rotated in a third rotation 63 in the opposite unlocking direction while a force is simultaneously pushing the lid upward, causing it to assume a raised position, unlocking is not immediately possible. The rotation only proceeds to a fourth rotation position 54. For example, a pressure pocket described above has been approached. As soon as the lid is back in the normal position, a fourth rotation 64 to the fifth rotation position 55 can be performed and the pressure pocket can be passed. Subsequently, in a fifth rotation 65, which can be performed in one step with the fourth rotation 64, the lid can be unlocked.

There may be a further, second rotational position 52 in which only the pot is locked to the base part, but the lid is not locked. This may advantageously be located between the initial position 50 and the fourth rotational position 54, in particular, as indicated, between the intermediate position 51 and the fourth rotational position 54.

If locking an attachment or function module is not successful, one or more further attempts can be made, e.g., three attempts, to implement the locking. There is usually no waiting time between attempts. If an attachment or function module cannot be unlocked, it can be checked, e.g., based on the rotary position of the operating part, whether the pressure pocket has been approached. If so, one or more attempts can be made again, e.g., four attempts, to unlock the attachment or function module. A waiting time is usually inserted between attempts. Waiting times can become longer with each repetition, e.g., 2 seconds, then 3 seconds, then 4 seconds, then 5 seconds. If not, one or more attempts can be made again, e.g., three attempts to implement the unlocking, usually without a waiting time.

In scenario C), a pot is used as an attachment. A function module is present that comprises a cutting attachment. The operating part is used to lock the pot and the function module. It is not possible to apply force to the inside of the lid. If the type of function module used is recognized, any one or more heating devices are deactivated.

Similar to FIG. 5, FIG. 6 shows functions of a design of the food processor depending on the rotational position of the operating part, for example in scenario C). Here, too, the function module is locked and unlocked on the attachment. The functions are similar to those described above, and to avoid repetition, only the differences are discussed here. When rotating in the unlocking direction, locking can be achieved immediately with the third turn 63.

If unlocking an attachment or function module is not successful, one or more further attempts can be made, e.g., three attempts, to unlock. There is usually no waiting time between attempts.

In scenario D), a different pot is used as the attachment. There is a function module in the form of a lid. There is no provision for locking the pot or the lid. One or both of the pot's heating elements can be heated via the corresponding electrical contacts. The pot may include a rotatable tool that can be operated optionally. Rotation of an operating part is not required in this scenario.

In scenario E), a pressure cooker is used as an attachment and a pressure-resistant lid with a controllable valve for pressure relief is used as a function module. The operating part can be used to control the valve, in particular by using a transmission device. In addition to or as an alternative to some or all of the rotary positions shown in FIGS. 5 or 6, there may be a sixth rotary position in which the valve is closed, a seventh rotary position in which the valve is minimally open, e.g., with an opening cross-section of 1% of the full opening, for example to release high pressure, an eighth rotary position in which the valve is half open, e.g. with an opening cross-section of 50%, and/or a ninth rotational position in which the valve is fully open. The sixth rotational position may be at 0°, the seventh rotational position at slightly above 0°, the eighth rotational position at 8° and/or the ninth rotational position at 16°.

In scenario F), a pressure cooker is used as an attachment and a lockable, pressure-resistant lid with a controllable valve for pressure relief is used as a function module. In addition to controlling the valve, the operating part can be used to lock and unlock the pot. In addition to or as an alternative to some or all of the rotational positions shown in FIGS. 5 or 6, there may be a sixth rotational position corresponding to a basic position and/or 0° position in which the valve is closed and the pot is not locked, a seventh rotational position in the form of an intermediate position described above, e.g., at 12° an eighth rotational position in which the pot and lid are locked and the valve is closed, e.g., at 30°, as well as further rotational positions in which the pot and lid remain locked and the valve is open as follows: a ninth rotation position in which the valve is minimally open, e.g., with an opening cross-section of 1% of the full opening, for example at 31°, for example to release high pressure, a tenth rotation position in which the valve is half open, for example at 38°, and/or an eleventh rotation position in which the valve is fully open, for example at 46°. One or more heating devices can be used as in scenario D).

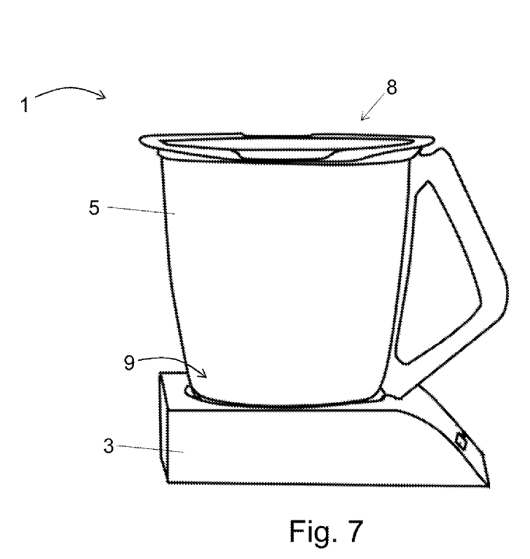

FIG. 7 shows a food processor 1 comprising a base part 3 with an interface 9 for mechanical and electrical coupling with an attachment 5. An attachment 5 has been inserted into the interface 9.

### List of Reference Signs

Food processor 1

Base part 3

Attachment 5

Interface 6

Function module 7

Handle 8

Interface 9, 9'

Operating part 10

Insertion element 11

Actuator 12

Contact element 13

Contact surface 14

Electrical contact 17, 17'

Control device 18

Receiving unit 19

Position sensor 20

Sensor 23

Transmission device 25

Display 30

Foot 31

Gear wheel 33

Contour 35, 35'

Locking hook 37

Recess 39

Connecting ring 40

Hook 42

Bayonet geometry 44

Ring 46

Pressure pocket 47

Initial position 50

Intermediate position 51

Second rotation position 52

Third rotation position 53

Fourth rotation position 54

Fifth rotation position 55

Confidence range 56

Too far 57

Rotation angle α

First rotation 61

Second rotation 62

Third rotation 63

Fourth rotation 64

Fifth rotation 65

1. Food processor comprising
a base part, wherein the base part has an interface for mechanical and/or electrical coupling with an attachment,
wherein the food processor is configured to recognize a type of attachment and, depending on the recognized type of attachment to influence a function of the interface in order to operate the attachment for food preparation.

2. The food processor of claim 1, wherein the interface comprises a rotatable operating part for performing a function at the attachment, the base part comprising an actuator for driving the operating part, wherein the food processor is configured to control the actuator depending on the recognized type of attachment in order to influence a position or movement of the operating part.

3. The food processor of claim 1, wherein the interface comprises a plurality of electrical contacts for transmitting data and/or electrical energy between the base part and the attachment, wherein the food processor is configured to control the use of at least one electrical contact depending on the recognized type of attachment.

4. The food processor of claim 2, further comprising a position sensor for detecting a rotational position of the operating part.

5. The food processor of claim 1, wherein the interface has a receiving unit for receiving information for the purpose of recognizing the type of attachment, wherein the receiving unit in particular comprises at least one electrical contact of a data interface.

6. The food processor of claim 1, wherein the base part has access to properties of the recognized attachment and is configured to control the function of the interface depending on the properties of the attachment.

7. The food processor of claim 1, further comprising the attachment, wherein the attachment is a food preparation vessel, wherein the attachment has an interface for mechanical coupling with a function module, wherein the function module is in particular a cover part for the attachment or a chopping part for chopping food.

8. The food processor of claim 7, wherein the food processor is configured to recognize a presence and type of the function module and to influence a function of the interface depending on the detected presence and/or type, wherein, in particular, a receiving unit is arranged on the attachment for receiving information for the purpose of recognizing the type of the function module.

9. The food processor of claim 2, further comprising the attachment, wherein the attachment has a transmission device for transmitting movement of the operating part for the purpose of executing a function at the function module.

10. The food processor of claim 9, wherein the base part and the attachment are configured such that
in an initial position of the operating part, the attachment can be mechanically coupled to the base part,
in a second rotational position of the operating part that is different from the initial position, the attachment is locked to the base part, and
in a third rotational position of the operating part that is different from the initial position and the second rotational position, at least one locking element of the attachment that is operatively connected to the transmission device connected to the transmission device is in a locking position in order to lock a function module.

11. The food processor of claim 1, wherein the food processor is configured to adapt the function of the interface depending on a current operating state of the food processor.

12. The food processor of claim 1, further comprising the function module, wherein the function module is a cover for covering the attachment, wherein, in the event of a force acting on the function module from below, the function module assumes a raised position in which it is not possible to unlock the function module, wherein the food processor is configured to recognize whether the type of attachment and the function module allow the raised position of the function module and, if so, to insert a waiting time after a failed attempt to unlock the function module and then to make a new attempt to unlock the function module.

13. The food processor of claim 1, wherein the food processor is configured to execute a function of the interface based on a user input or an electronically stored recipe, wherein the food processor is configured such that, in response to an instruction from the user or the recipe, the function of the interface is executed depending on a recognized type of attachment and/or function module.

14. The food processor of claim 13, wherein the food processor is configured to check, before or during the operation of a functional component according to the instruction of the user or the recipe, whether the operation according to the instruction of the user or the recipe is permissible for the type of attachment and/or function module, and to refrain from operating the function component according to the user's instructions or the recipe if operation according to the instructions is not permissible.

15. Method for preparing a food using a food processor according to claim 1, comprising the steps of:
recognizing, by the food processor, a type of attachment mechanically and/or electrically coupled to the base part,
influencing, by the food processor, a function of the interface depending on the recognized type of attachment,
wherein influencing in particular comprises: moving an operating part of the interface into a position predetermined by the type of attachment and/or an operating state of the food processor.

16. The method of claim 15, further comprising:
recognizing, by the food processor, a type of function module mechanically coupled to the attachment,
influencing, by the food processor, a function of the interface depending on the recognized type of function module,
wherein influencing in particular comprises: moving an operating part of the interface into a position predetermined by the type of the function module and/or an operating state of the food processor.
